(19) United States
(12) Patent Application Publication
(10) Pub. No.: US 2008/0171569 A1
(43) Pub. Date: Jul. 17, 2008

(54) REDUNDANT WIRELESS BASE STATIONS

(76) Inventors: Chad A. Pralle, (US); Charles H. Immendorf, (US); Eamonn F. Gormley, Redmond, WA (US)

Correspondence Address: HOLLAND & KNIGHT LLP, 10 ST. JAMES AVENUE, 11th Floor, BOSTON, MA, 02116-3889, US

(21) Appl. No.: 11/623,992

(22) Filed: Jan. 17, 2007

(51) Int. Cl. H04Q 7/30; H04Q 7/34

(52) U.S. Cl. 455/525; 455/524

(57) ABSTRACT

A wireless network includes a wireless subscriber station radio-linked to a set of redundant wireless base stations, the set including a primary wireless base station connected to a secondary base station by a link, the link enabling sending and receiving baseband radio data to and from a radio or to and from another base station, a first base radio unit (BRU) connected to the primary wireless base station and a second BRU connected to the secondary base station, a data link connecting the primary wireless base station to the secondary wireless base station.

### BACKGROUND

The present invention relates to wireless networks, and more particularly to redundant wireless base stations.

Wireless uses electromagnetic waves to transmit data between devices. The term refers to communication without cables or cords, chiefly using radio frequency and infrared waves.

### SUMMARY

The present invention provides methods and apparatus for redundant wireless base stations.

In an aspect, the invention features a system including a primary wireless base station connected to a secondary wireless base station by a link, the link enabling a sending and a receiving of baseband radio data to and from a radio or to and from another base station, a first base radio unit (BRU) connected to the primary wireless base station, a second BRU connected to the secondary base station, and a data link connecting the primary wireless base station to the secondary wireless base station.

In embodiments, the link can be an Open Base Station Architecture Institute (OBSAI) link, an IF interface using coaxial connections, a IEEE 802.3 Ethernet link, or a Common Public Radio Interface (CPRI) link.

The primary wireless base station can be a primary Advanced Mezzanine Card (AMC) module and the secondary wireless base station can be a secondary AMC module, the primary and secondary AMC modules mounted in a single wireless base station implemented in a Advanced Telecom Computing Architecture (ATCA) platform.

The primary wireless base station can be a master operating wireless base station and the secondary base station can be a standby wireless base station. The data link can pass status and keep alive messages generated by the primary wireless base station and the secondary wireless base station.

The system can include an element management server linked to the data link. The element management server can arbitrate switch over from the primary wireless base station to the secondary wireless base station on an occurrence of an event. The event can be selected from the group consisting of primary wireless base station failure, first BRU failure, data link failure and link failure.

The element management server can maintain copies of wireless services and base stations configuration databases resident in the primary wireless base station and the secondary wireless base station.

In another aspect, the invention features a wireless network including a wireless subscriber station radio-linked to a set of redundant wireless base stations, the set including a primary wireless base station connected to a secondary base station by a link, the link enabling sending and receiving baseband radio data to and from a radio or to and from another base station, a first base radio unit (BRU) connected to the primary wireless base station and a second BRU connected to the secondary base station, and a data link connecting the primary wireless base station to the secondary wireless base station.

In embodiments, the primary wireless base station can be a master operating base station and the secondary base station can be a standby wireless base station. The data link can pass status and keep alive messages generated by the primary wireless base station and the secondary wireless base station.

An element management server can arbitrate switch over from the primary wireless base station to the secondary wireless base station on an occurrence of an event. The event can be selected from the group consisting of primary wireless base station failure, first BRU failure, data link failure and link failure.

The element management server can maintain copies of wireless services and base stations configuration databases resident in the primary wireless base station and the secondary wireless base station.

In another aspect, the invention features a network process including monitoring redundant master-slave base stations and associated radio transceivers in a wireless network over a data link for an occurrence of an event, the redundant master-slave base stations sharing information over a link, the link enabling sending and receiving baseband radio data to and from a radio or to and from another base station, and upon receipt of an event, downloading wireless services and base stations configuration databases resident in the master wireless base station to the slave wireless base station.

In embodiments, the method can include enabling current base station operations to switch from the master wireless base station to the slave wireless base station. The method can include sending an alarm to a system administrator.

The event can be selected from the group consisting of master wireless base station failure, BRU failure, data link failure and link failure.

In another aspect, the invention features a system including a primary wireless base station connected to a secondary wireless base station by a link, the link enabling sending and receiving baseband radio data to and from a radio or to and from another base station, a first base radio unit (BRU) connected to the primary wireless base station, a second BRU connected to the secondary base station, a radio link in the secondary base station enabling the first base station to connect to the second BRU through the secondary base station, and a data link connecting the primary wireless base station to the secondary wireless base station.

In embodiments, the primary base station can be configured to operate in a standalone mode using the first BRU and second BRU.

The primary base station and the secondary base station can be configured to operate in a redundant mode.

The link can be an Open Base Station Architecture Institute (OBSAI) link, an IF interface using coaxial connections, a IEEE 802.3 Ethernet link, or a Common Public Radio Interface (CPRI) link.

The primary wireless base station can be a primary Advanced Mezzanine Card (AMC) module and the secondary wireless base station can be a secondary AMC module, the primary and secondary AMC modules mounted in a single wireless base station implemented in a Advanced Telecom Computing Architecture (ATCA) platform.

The primary wireless base station can be a master operating wireless base station and the secondary base station can be a standby wireless base station. The data link can pass status and keep alive messages generated by the primary wireless base station and the secondary wireless base station.

The system can include an element management server linked to the data link. The element management server can arbitrate switch over from the primary wireless base station to the secondary wireless base station on an occurrence of an event. The event can be selected from the group consisting of primary wireless base station failure, a BRU failure, data link failure and link failure.

The element management server can maintain copies of wireless services and base stations configuration databases resident in the primary wireless base station and the secondary wireless base station.

The system can include a third base station linked to the primary base station.

The invention can be implemented to realize one or more of the following advantages.

A wireless base station can be configured to operate as a standalone base station or in conjunction with another base station to provide redundant operation.

A base station redundancy feature enables the replacement of failed base stations without losing connectivity to the subscriber stations that communicate with the failed based station.

When a BRU radio unit is replaced, diversity over the sector affected is restored after equipment initialization. When a base station is replaced, full diversity and redundancy support is restored as the new base station is initialized and becomes a new hot standby base station.

Base station redundancy enables a cost efficient, highly reliable and flexible configuration to rapidly deploy high availability services with redundancy and hot swap replacement capability essential to wireless carriers, while preserving an economical advantage over rack mount shelves.

Redundant wireless base stations can be used to enable fixed, nomadic, portable and/or mobile multimedia services including, but not limited to, voice, video, Internet, gaming, download/upload (e.g., music, movies, pictures, ring tones, and so forth), voice mails, emails, message text, Internet Protocol (IP) Virtual Private Network (VPN), Video conferencing, IP Private Branch Exchange (PBX) backhaul, cellular backhaul, Time Division Multiplexing (TDM) and IP network backhaul including hot zone backhaul, Supervisory Control and Data Acquisition (SCADA), and so forth.

The redundant scheme can be implemented in an Advanced Telecom Computing Architecture (ATCA) platform between Advanced Mezzanine Card (AMC) modules within a wireless base station.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary broadband wireless network.

FIG. 2 is a block diagram of the redundant master/slave base stations.

FIG. 3 is a flow diagram.

Like reference numbers and designations in the various drawings indicate like elements.

### DETAILED DESCRIPTION

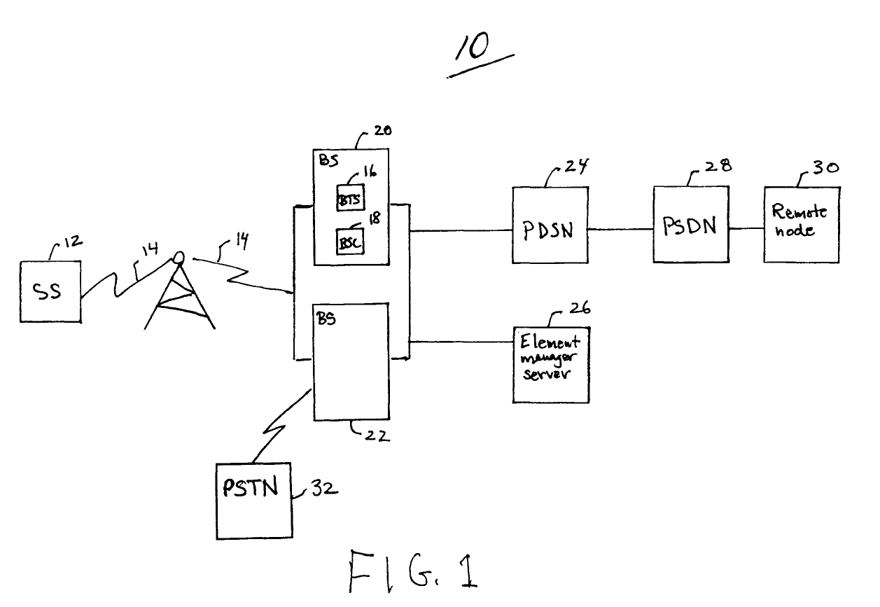

As shown in FIG. 1, an exemplary broadband wireless network 10 includes a subscriber station (SS) 12 communicating over an air link 14 with a base transceiver station (BTS) 16 and in turn with a base station controller (BSC) 18. Here, the BTS 16 and BSC 18 cooperatively define a master base station (BS) 20. Master base station 20 is linked to a slave base station 22, which, as described below, enables redundancy features to maximize the availability of wireless network 10 and the support of critical applications executing within the wireless network 10. The redundant base stations 20, 22, along with the use of radio diversity, enable one plus one redundancy of a multiple sector base station and the radio transceivers.

The air link 14 is a radio-frequency portion of a circuit between the subscriber station 12 and base stations 20, 22. Base stations 20, 22 are coupled together by a data link, such as an Ethernet link, which enables communication to a packet data serving node (PDSN) 24 and an element management server 26. The PDSN 24 enables connectivity with a packet switched data network 28, such as the Internet. A remote node 30 may in turn sit on or be accessible via the packet switched data network 28. In other examples, each of the base stations 20, 22 can communicate with a public switched telephone network (PSTN).

The element management server 26 provides network system administrators with a complete set of management tools to enable the configuration, management, monitoring, and reporting of all elements in the wireless network 10. For example, the element management server 26 enables secure centralized and remote configuration of base stations, subscriber stations, switches, and other network elements. The element management server 26 reports and alerts network system administrators to alarms and faults in the network 10, and monitors system performance.

The subscriber station 12 can take various forms. For example, the subscriber station 12 can be a cellular or personal communications services (PCS) telephone, a notebook computer or personal digital assistant (PDA) that includes or is connected with a cellular or PCS telephone or with a wireless communications card or a fixed wireless terminal. Other examples are possible as well.

End-to-end communication is established from the subscriber station 12 to the remote node 30 over a packetized communication path including the air link 14 between the subscriber station 12 and the master base station 20 or slave base station 22, the air link 14 between the master base station 20 or slave base station 22 and the PDSN 24, and the packet-switched network 28 between the PDSN 24 and the remote node 30. End-to end communication can also be established from the subscriber station 12 to a circuit switched network over a communication path including the air link 14 between the subscriber station 12 and the master base station 20 or slave base station 22 and the circuit switched network.

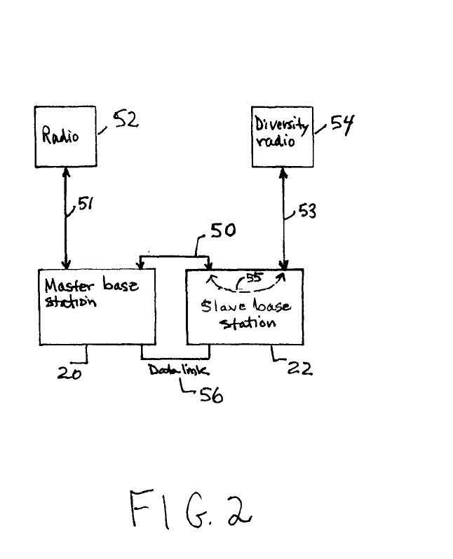

As shown in FIG. 2, the master base station 20 and the slave base station 22 include several input/output (I/O) ports. In this example, a link 50 connects an I/O port of the master base station 20 and the slave base station 22. Example links include, for example, an Open Base Station Architecture Institute (OBSAI) link, a standard IF interface using a coaxial connection instead of fiber optic links, a proprietary optical or electrical interface, a IEEE 802.3 based Ethernet link including but not limited to 1000BaseSx for baseband radio signal transmissions, Common Public Radio Interface (CPRI), and so forth. The link 50 enables sending and receiving baseband radio data to and from a radio or to and from another base station. Thus, the link 50 provides flexibility for numerous configurations.

Each base station 20, 22 includes radio links 51, 53 to Base Radio Unit (BRU) radio transceivers 52, 54. Traffic from master base station 20 and slave base station 22 can flow over the link 50 to the BRU radio transceivers 52, 54, e.g., traffic sent from master base station 20 and radio transceiver 52 is sent to slave base station 22 and radio transceiver 54 over the link 50. The radio links 51, 53 can be OBSAI links and are of the same type as link 50. The master base station 20 can communicate with both radio transceivers 52, 54 using the link 55.

A data link 56 passes data, e.g., status and keep alive messages, provisioning data, service data, configuration data, and so forth, between the master base station 22 and the slave base station 22. The master base station 20 and the slave base station 22 are in synchronization with the element management server 26.

In another example, a first and second master base station can be configured with a single slave base station to enable further redundancy.

In still another example, since each base station includes two radio link ports, a single base station is linked directly the radio transceivers 52, 54 if redundancy is not desired. If redundancy of base stations is desired, the master base station 20 is linked to the radio transceiver 52 through a master base station first port while a master base station second port links the master base station 20 to the radio transceiver 54 through link 55 of the slave base station 22. In the redundant configuration, switchover to the slave base station 22 enables the slave base station 22 to communicate with the radio transceiver 52 over links 50, 51 and with the radio transceiver 54 over link 53.

The element management server 26 arbitrates switch over from the master base station 20 to the slave base station 22 and downloads services and configuration databases from the master base station 20 to the slave base station 22, when a switch is activated upon the occurrence of one or more events. Example events include master base station 20 failure or radio transceiver 52 failure. When the slave base station 22 assumes control after a switchover from the master base station 20, the slave base station 22 can communicate with both radio transceiver 52, 54 using the link 55.

In one example, a failure in one BRU radio transceiver is detected by the element management server 26, which causes the corresponding base station to stop transmitting. The element management server 26 causes a transfer of functions of the failed base station to the other functioning BRU radio transceiver and base station, resulting in continued network services. The failed BRU radio transceiver can be replaced while most service connections remain available, with no diversity benefit until the failed BRU radio transceiver is replaced. BRU radio transceivers are typically interfaced using fiber optics and separate power, so each BRU radio transceiver can be replaced without powering down the other, properly functioning, BRU radio transceivers and base stations.

When a “keep alive” signal between the master base station 20 and the hot standby slave base station 22 is interrupted, the element management server 26 arbitrates the failure and fitness of each base station 20, 22. The element management server 26 then decides which base station should fill the role as the master base station to the network 10.

In one example, a base station may loose an ability to communicate (e.g., network interface failure). In this example, the element management server 26 gives master control to the operating base station until the failed base station is replaced.

In another example, a network interface failure in combination with a lost “keep alive” signal between the master base station 20 and the slave base station 22 causes each base station 20, 22 to lose redundancy benefits and to take over functions on their own.

When “keep alive” signals are lost, an individual base station can function to shut down transmissions that the element management server 26 cannot. In this event, each BRU radio transceiver 52, 54 monitors a status of the base stations 20, 22 over the link 50. If the BRU radio transceiver detects a failure or anomaly, the BRU radio transceiver automatically shuts down to avoid corruption of any other components in the network 10.

If the master base station 20 is lost, the hot standby slave base station 22 is instructed by the element management server 26 to take over and proceed to subscriber station commissioning on the network 10. As described above, provisioning information is available from the element management server 26 to both the master base station 20 and the slave base station 22 at any moment because information is shared and available over the data link 56.

Any failure in the network 10 is reported by the element management server 26, which generates an alarm and an event report to the network administrator to enable maintenance to be conducted.

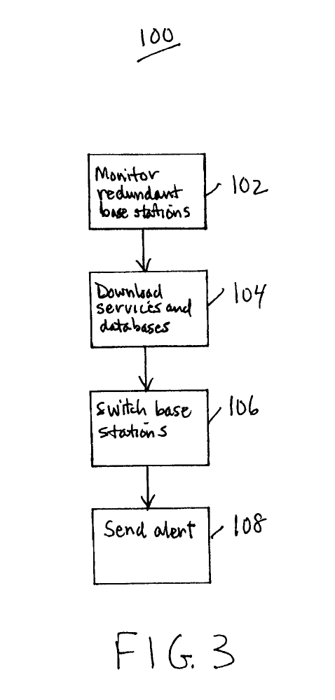

As shown in FIG. 3, a process 100 includes monitoring (102) redundant master-slave base stations and associated radio transceivers in a wireless network over a data link for an occurrence of an event. The redundant master-slave base stations share information over a link. An event can include, for example, master wireless base station failure, BRU failure, data link failure and/or link failure. Upon receipt of an event, process 100 downloads (104) wireless services and base stations configuration databases resident in the master wireless base station to the slave wireless base station. Process 100 causes (106) current base station operations to switch from the master wireless base station to the slave wireless base station, which becomes the primary operating base station. Process 100 sends (108) an alarm to a system administrator, enabling repair of the failed unit in the wireless network.

It is to be understood that the foregoing description is intended to illustrate and not to limit the scope of the invention, which is defined by the scope of the appended claims. Other embodiments are within the scope of the following claims.

What is claimed is:

1. A system comprising:
a primary wireless base station connected to a secondary wireless base station by a link, the link enabling a sending and a receiving of baseband radio data to and from a radio or to and from another base station;
a first base radio unit (BRU) connected to the primary wireless base station;
a second BRU connected to the secondary base station; and
a data link connecting the primary wireless base station to the secondary wireless base station.

2. The system of claim 1 wherein the link is an Open Base Station Architecture Institute (OBSAI) link.

3. The system of claim 1 wherein the link is an IF interface using coaxial connections.

4. The system of claim 1 wherein the link is IEEE 802.3 Ethernet link.

5. The system of claim 1 wherein the link is Common Public Radio Interface (CPRI) link.

6. The system of claim 1 wherein the primary wireless base station is a primary Advanced Mezzanine Card (AMC) module and the secondary wireless base station is a secondary AMC module, the primary and secondary AMC modules mounted in a single wireless base station implemented in a Advanced Telecom Computing Architecture (ATCA) platform.

7. The system of claim 1 wherein the primary wireless base station is a master operating wireless base station and the secondary base station is a standby wireless base station.

8. The system of claim 1 wherein the data link passes status and keep alive messages generated by the primary wireless base station and the secondary wireless base station.

9. The system of claim 1 further comprising an element management server linked to the data link.

10. The system of claim 9 wherein the element management server arbitrates switch over from the primary wireless base station to the secondary wireless base station on an occurrence of an event.

11. The system of claim 10 wherein the event is selected from the group consisting of primary wireless base station failure, first BRU failure, data link failure and link failure.

12. The system of claim 9 wherein the element management server maintains copies of wireless services and base stations configuration databases resident in the primary wireless base station and the secondary wireless base station.

13. A wireless network comprising:
a wireless subscriber station radio-linked to a set of redundant wireless base stations, the set comprising a primary wireless base station connected to a secondary base station by a link, the link enabling sending and receiving baseband radio data to and from a radio or to and from another base station, a first base radio unit (BRU) connected to the primary wireless base station and a second BRU connected to the secondary base station, and a data link connecting the primary wireless base station to the secondary wireless base station.

14. The wireless network of claim 13 wherein the primary wireless base station is a master operating base station and the secondary base station is a standby wireless base station.

15. The wireless network of claim 13 wherein the data link passes status and keep alive messages generated by the primary wireless base station and the secondary wireless base station.

16. The wireless network of claim 13 wherein an element management server arbitrates switch over from the primary wireless base station to the secondary wireless base station on an occurrence of an event.

17. The wireless network of claim 16 wherein the event is selected from the group consisting of primary wireless base station failure, first WBRU failure, data link failure and link failure.

18. The wireless network of claim 13 wherein the element management server maintains copies of wireless services and base stations configuration databases resident in the primary wireless base station and the secondary wireless base station.

19. A network process comprising:
monitoring redundant master-slave base stations and associated radio transceivers in a wireless network over a data link for an occurrence of an event, the redundant master-slave base stations sharing information over a link, the link enabling sending and receiving baseband radio data to and from a radio or to and from another base station; and
upon receipt of an event, downloading wireless services and base stations configuration databases resident in the master wireless base station to the slave wireless base station.

20. The network process of claim 19 further comprising enabling current base station operations to switch from the master wireless base station to the slave wireless base station.

21. The network process of claim 19 further comprising sending an alarm to a system administrator.

22. The network process of claim 19 wherein the event is selected from the group consisting of master wireless base station failure, BRU failure, data link failure and link failure.

23. A system comprising:
a primary wireless base station connected to a secondary wireless base station by a link, the link enabling sending and receiving baseband radio data to and from a radio or to and from another base station;
a first base radio unit (BRU) connected to the primary wireless base station;
a second BRU connected to the secondary base station;
a radio link in the secondary base station enabling the first base station to connect to the second BRU through the secondary base station; and
a data link connecting the primary wireless base station to the secondary wireless base station.

24. The system of claim 23 wherein the primary base station is configured to operate in a standalone mode using the first BRU and second BRU.

25. The system of claim 23 wherein the primary base station and the secondary base station are configured to operate in a redundant mode.

26. The system of claim 23 wherein the link is an Open Base Station Architecture Institute (OBSAI) link.

27. The system of claim 23 wherein the link is an IF interface using coaxial connections.

28. The system of claim 23 wherein the link is IEEE 802.3 Ethernet link.

29. The system of claim 23 wherein the link is Common Public Radio Interface (CPRI) link.

30. The system of claim 23 wherein the primary wireless base station is a primary Advanced Mezzanine Card (AMC) module and the secondary wireless base station is a secondary AMC module, the primary and secondary AMC modules mounted in a single wireless base station implemented in a Advanced Telecom Computing Architecture (ATCA) platform.

31. The system of claim 23 wherein the primary wireless base station is a master operating wireless base station and the secondary base station is a standby wireless base station.

32. The system of claim 23 wherein the data link passes status and keep alive messages generated by the primary wireless base station and the secondary wireless base station.

33. The system of claim 23 further comprising an element management server linked to the data link.

34. The system of claim 23 wherein an element management server arbitrates switch over from the primary wireless base station to the secondary wireless base station on an occurrence of an event.

35. The system of claim 34 wherein the event is selected from the group consisting of primary wireless base station failure, a BRU failure, data link failure and link failure.

36. The system of claim 34 wherein the element management server maintains copies of wireless services and base stations configuration databases resident in the primary wireless base station and the secondary wireless base station.

37. The system of claim 23 further comprising a third base station linked to the primary base station.
